(19) United States
(12) Patent Application Publication
(10) Pub. No.: US 2016/0345287 A1
(43) Pub. Date: Nov. 24, 2016

(54) TRANSMITTER LOCALIZATION METHOD AND SYSTEM BASED ON THE RECIPROCITY THEOREM USING SIGNAL STRENGTH MEASUREMENTS

(71) Applicant: The Provost, Fellows, Foundation Scholars and the other members of Board, of the College of the Holy, Dublin 2 (IE)

(72) Inventors: Eamonn O'Nuallain, Dublin 2 (IE); Eamonn Kenny, Dublin 2 (IE)

(73) Assignee: The Provost, Fellows, Foundation Scholars and the other members of Board, of the College of the Holy, Dublin 2 (IE)

(21) Appl. No.: 15/162,462

(22) Filed: May 23, 2016

Related U.S. Application Data
(60) Provisional application No. 62/165,426, filed on May 22, 2015.

(51) Int. Cl. H04W 64/00; G01S 5/02

(52) U.S. Cl. CPC H04W 64/00; G01S 5/0205

(57) ABSTRACT

The invention provides a system and method of locating a non-cooperative transmitter in a network based on a received signal strength (RSS) comprising the steps of: observes the differences in both downlink and uplink signal losses for the transmitter to be located and a small number of receiver pairs; calculating the difference in downlink signal losses for each receiver pair is obtained by measuring the RSS; comparing the calculated values generated for the uplink using a propagation predictor; predicting the location of the non-cooperative transmitter in the network.

The application claims the benefit of U.S. Provisional Patent Application No. 62/165,426, filed 22 May 2015, the specification of which is hereby incorporated herein by reference.

### BACKGROUND OF THE INVENTION

1. Field of the Invention

The invention relates to a method and system for locating a transmitter.

2. Description of Related Art

Localisation is now an integral part of modern communications. Localisation provides the means by which demand-driven location-aware services such as navigation, location-based services/advertising, location-based access and tracking etc. are provided. Other examples include localisation for network security purposes, routing in mobile ad-hoc networks (MANETS), localization for emergency and security operations and localisation of a primary user in cognitive radio so as to avoid causing unwanted interference.

Localization methods based on signal strength have been used for decades. They are attractive because they require little dedicated hardware and are consequently cheap to implement. Knowing the power output of the transmitter, they are generally based on fitting signal strength readings to a path-loss model using a statistical model to represent large-scale fading and performing lateration to locate the transmitter. However this approach is easily confounded if the path-loss model and signal variance appropriate to the propagation environment is not used and if there are significant changes in the propagation environment itself—such as from suburban to rural etc. Signal strength-based methods are, as a consequence of these factors, are prone to significant error making them less accurate that other widely used methods, such as that disclosed in S. A. Zekavat, R. M. Buehrer (Ed.), “Handbook of Position Location—Theory, Practice and Advances”, pp. 360, IEEE Press 2012.

Another signal strength-based approach, termed ‘fingerprinting’ (see for example K. C. Takenga, “Mobile positioning based on pattern-matching and tracking techniques,” ISAST Trans. Commun. Netw., vol. 1, no. 1, pp. 529-532, August 2007 and the closely related Neural Cellular Positioning System (M. Vossiek, L. Weibking, P. Gulden, J. Wieghardt, C. Hoffmann, P. Heide, ‘Wireless Local Positioning’, IEEE Microwave mag., December 2003), generates a signal strength map over a given area using signal strength readings obtained by doing a site survey. The signal strength reading at the user end is compared with this map in order to establish its location. Interpolation in the regions between the locations where signal strength has been pre-established is performed using a statistical model. The method is elaborate requiring a detailed site survey and a ‘training phase’ and is consequently expensive.

In summary, current signal-strength-based localization methods require knowledge of channel parameters and are currently less accurate than other methods such as Time of Arrival (ToA) and Angle of Arrival (AoA). They are also sometimes, such as in the case of fingerprinting, more elaborate than other widely used range-based methods (that is, methods that depend on characteristics of the transmitter signal) such as the well-known ‘fundamental’ localization methods that are ToA, Time Difference of Arrival (TDoA), AoA, Radar/Sonar and the Global Positioning System (GPS). However, by comparison with the methods referred to above, signal strength-based methods require relatively inexpensive dedicated hardware. A signal-strength meter is inexpensive and most wireless devices are now equipped with these. Also, with the exception of AoA, the above methods also depend on accurate time-synchronisation between the satellites or base stations/‘anchor nodes’ and the transmitter to be located. Time-synchronisation may prove difficult in dense multipath environments and Non-Line of Sight (NLOS) conditions thus degrading accuracy and in these situations some supplentary localisation method such as Differential GPS, ‘deadreckoning’ or an inertial navigation system (INS) may need to be deployed.

Range-free localization schemes, such as Radio Frequency IDentification (RFID), the Centroid Method and similar methods such as Cell-ID are simpler but are accurate only where there is either a large density of base-stations/‘anchor’ nodes in the network.

The invention aims to address the shortcomings, in particular as it pertains to non-cooperative transmitters, of currently deployed methods and systems in locating a transmitter in a network.

### BRIEF SUMMARY OF THE INVENTION

According to the present invention there is provided, as set out in the appended claims, a method of locating a non-cooperative transmitter in a network based on a received signal strength (RSS) comprising the steps of: observes the differences in both downlink and uplink signal losses for the transmitter to be located and a minimum of one receiver pair; calculating the difference in downlink signal losses for each receiver pair is obtained by measuring the RSS; comparing the calculated values generated for the uplink using a propagation predictor; predicting the location of the non-cooperative transmitter in the network.

The invention provides a novel localization method for both cooperative and non-cooperative transmitters based on Received Signal Strength (RSS). Because the downlink power is not always known, the method observes the differences in both downlink and uplink signal losses for the transmitter to be located and a small number of receiver pairs. The difference in downlink signal losses for each receiver pair is obtained by measuring the RSS. These are compared with those generated for the uplink using a propagation predictor. Using a Helmholtz Reciprocity Theorem, the location of the transmitter is predicted using the difference in the signal losses in the downlink for a receiver pair minus that in the uplink where the uplink transmissions are at the same arbitrary power.

In one embodiment there is provided a fast integral equation-based propagation predictor is used as a result of its ability to give an accurate prediction of large-scale fading.

In one embodiment the differences in measured RSS for each receiver pair (ri, rj) in the downlink, ΔLₖᵢⱼ^{d} are calculated for a lattice of potential transmitter locations {rk}.

In one embodiment the differences in the uplink SS, ΔLᵢⱼₖ^{k}, using the receiver pairs pair (ri, rj) for potential transmitters {rk}, each transmitting with the same arbitrary power, are calculated as a function of location using a propagation predictor.

In one embodiment the residual function εkij is calculated for each receiver pair and each potential transmitter as defined by the following equation:

εₖᵢⱼ [symbol] ΔLₖᵢⱼ^{d}−ΔLᵢⱼₖ^{u}

In one embodiment a discrete function Ξ! is calculated by summing over all receiver pair groupings as defined by:

$${Ξ}_{k} = {\sum }_{i = 1}^{R} {\sum }_{j = 1}^{i} {∈}_{kij}$$

In one embodiment the discrete function Ξ! is smoothed to eliminate spurious minima.

In one embodiment the location of the transmitter is estimated to be given by the location of an absolute minimum. The absolute minimum can be defined the absolute minimum of min(Ξ)=min_{∀k}Ξₖ determined using a search routine.

In one example he resulting location accuracy is 13.7 m using twelve receivers over a terrain profile of 7.8 Km in length. The computation time was 89 s. The method offers significant advantages over other current methods such as the ability to locate a non-cooperative transmitter, there is no synchronisation necessary and the method is resilient to signal fading and NLOS conditions.

Furthermore, the method does not rely on empirical environment dependent data nor is a detailed site survey necessary, such as with fingerprinting. The method requires the means to measure the RSS in the downlink and to accurately compute signal strength versus distance. The method however does not require dedicated hardware apart from signal strength meters at the receivers and a computer to predict signal strength. As a result the method is relatively inexpensive and simple to implement.

In another embodiment there is provided method of locating a transmitter in a network based on a received signal strength (RSS) comprising the steps of:
observing the differences in both downlink and uplink signal losses for the transmitter to be located and a minimum of one receiver pair;
calculating the difference in downlink signal losses for each receiver pair obtained by measuring the RSS;
comparing the calculated values generated for the uplink using a propagation predictor; and
predicting the location of the non-cooperative transmitter in the network from the comparing step.

In a further embodiment there is provided a computer implemented system for locating a non-cooperative transmitter in a network based on a received signal strength (RSS), said system configured with one or more modules to:
observe the differences in both downlink and uplink signal losses for the transmitter to be located and a minimum of one receiver pair;
calculate the difference in downlink signal losses for each receiver pair obtained by measuring the RSS;
compare the calculated values generated for the uplink using a propagation predictor; and
predict the location of the non-cooperative transmitter in the network from the comparison.

There is also provided a computer program comprising program instructions for causing a computer program to carry out the above method which may be embodied on a record medium, carrier signal or read-only memory.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The invention will be more clearly understood from the following description of an embodiment thereof, given by way of example only, with reference to the accompanying drawings, in which:

FIG. 1 illustrates a plot of terrain height versus distance. The transmitter is located 10.4 m above the origin;

FIG. 2 illustrates a plot of measured and predicted signal strength versus distance from the transmitter. The receiver height is 2.4 m above the surface; and

FIG. 3 illustrates a plot of the sum of the absolute values of the residual functions versus distance from the transmitter and transmitter height. The function minimum is located near the origin where the transmitter is approximately located.

### DETAILED DESCRIPTION OF THE DRAWINGS

The invention provides a new signal strength based localisation method is introduced that aims to address the drawbacks of current signal strength-based methods, some of which were discussed above, while maintaining cost-effectiveness.

The method has as its input a minimum of two signal strength readings taken at various locations. An accurate propagation predictor is used but a site survey is not required. Based on this information the invention shows how to estimate the location of the transmitter without the need for synchronisation or the cooperation of the transmitter to be located. The method is accurate, is not reliant on empirical environment-dependent parameters, is capable of dealing with changing physical environments, is resilient to large-scale fading (shadowing) and is unaffected by NLOS conditions. As a signal-strength-based method it maintains its cost-effectiveness.

To put the signal strength-based localisation method introduced here in context, examples of how the method, given its inherent advantages, would be particularly useful are now given. For network security it is sometimes necessary to locate with precision a non-cooperative user that is either attacking the network or engaging in some other sort of nefarious or malicious activity.

There is a need to physically locate a rogue device in a wireless network given that its logical network identifier may easily be spoofed. In the case of an emergency/disaster situation the robustness of the method makes it particularly useful in accurately locating an emergency call (e.g. Enhanced 911) or routing in MANETS.

Another pertinent application is in the domain of cognitive radio where it is necessary to locate non-cooperative incumbent transmitters, with devices where cost effectiveness is key (e.g. mobile phones), so as to avoid interfering with them.

The propagation predictor model chosen to illustrate the method is a computational electromagnetics-based method. It is important to note however that any propagation predictor can be used. A propagation predictor that predicts large-scale fading will give best results. Specifically, the propagation predictor used here is based on the Electric Field Integral Equation (EFIE). This method necessitates solving the EFIE for the electrical current induced on the surface (i.e. terrain) as a result of irradiation by the transmitter. From this solution the field scattered from the surface is obtained. The total field at points above the surface is then the sum of the incident field from the transmitter and the scattered field. Solving the EFIE in its canonical form is computationally very expensive. However many advances have been made to speed up solving the EFIE for propagation over terrain so that this is no longer an impediment.

As mentioned already any propagation predictor, in particular one that predicts large-scale fading accurately can be used. Ray-tracing may be considered as an alternative to an integral equation-based method. Ray Tracing is however a more complex algorithm and it does not deal with the phenomenon of diffraction about complex surfaces (such as terrain) as readily as an integral equation-based method because, in this respect, it is restricted to canonical solutions (i.e. for wedges, cylinders etc.).

Methodology

The method introduced according to one aspect of the present invention is based on the Helmholtz Reciprocity Theorem which states that: ‘A point source at Po will produce at P the same effect as a point source of equal intensity placed at P will produce at Po’—see Born M., Wolf E., ‘Principles of Optics—Electromagnetic Theory of Propagation, Interference and Diffraction of Light’, 7th ed., Cambridge University Press, 1999.

By direct application of the Helmholtz Reciprocity Theorem one can obtain a set of potential locations rₒ for a base station transceiver (BTS) whose output power Pₒ is known by taking the RSS at a mobile transceiver location r! and using a propagation predictor which predicts the signal loss Lₒᵢ from that mobile transceiver were a transmitter with the same output power Pₒ (i.e. as that of the transmitter) placed there. At those locations where the computed SS are the same as the originally read RSS at the location mentioned above, potential locations for the original transmitter is obtained. If this process is repeated for a number of receiver locations then incorrect transmitter locations can be eliminated until just one location for the transmitter is left. This method however requires knowledge of the transmit power.

Where one does not know the power of the BTS Pₒ, one can use the following method: where a second mobile transceiver rₒ is introduced at a different location from the first mobile transceiver rᵢ. It is recognized from the Reciprocity Theorem that the uplink and downlink losses are the same for each -transceiver pair. Consequently the difference between the uplink losses |Lⱼₒ^{u}−Lᵢₒ^{u}| of the two transceivers equals the difference between their downlink losses |Lₒᵢ^{d}−Lₒᵢ^{d}|.

The method measures the RSS at both transceivers and calculate the difference in the downlink losses (denoted ΔLₒᵢⱼ^{d} [symbol] |Lₒᵢ^{u}−Lₒⱼ^{u}|ₘₑₐₛ). Using a propagation predictor, it is possible to calculate the differences in the uplink losses (denoted ΔLᵢⱼₒ^{u} [symbol] |Lᵢₒ^{u}−Lⱼₒ^{u}|_{pred}).

It is important to note here that one should use the same arbitrary transmit power at both receivers in this step otherwise the correct difference in uplink signal losses will not be obtained. In an ideal scenario, the locations where the difference in the predicted uplink losses equals the difference in the measured downlink losses for each receiver pair (rᵢ, rⱼ), are candidates for the location for the BTS. That is the position where the residual error εₒᵢⱼ is smallest given by:

εₒᵢⱼ≡ΔLₒᵢⱼ^{d}−ΔLᵢⱼₒ^{u} (1)

The same process is then repeated using receiver pairs at different locations and, as before, to successively eliminate potential transmitter locations until only one is left. Such a process can be easily implemented in a wireless network where the nodes (at different locations) can act as receiver pairs.

To illustrate the reasoning behind the process an example is given. One can start with the case where the transmitter power is known. Suppose one has a BTS of power 0 dBm and a mobile transceiver ‘A’ located 1 Km away from this transmitter. The received power at receiver A is −30 dBm. If one were to interchange the locations of transmitter and receiver then, where the transmitter is still transmitting at 0 dBm, there will be a RSS of −30 dBm at the new location of receiver A. This fact can be used to determine the location of the original BTS. The method can simply deduce, with the transmitter and receiver locations interchanged, any location where the RSS is −30 dBm is a potential location for the original transmitter. The process is repeated for more BTSs at different locations and so narrow down the number of potential transmitter locations to one.

Now let's say the power of the transmitter (at its original location) is an unknown ‘P_{T}’. It is clear that the above strategy will not work since PT is not known and so cannot determine the signal loss. To deal with this problem a second receiver is introduced, located at say, 2 Km distant from the transmitter. The RSS at this receiver is, say, −70 dBm. The difference in the downlink powers is thus 40 dBm. This value will equal the difference in the uplink powers at the transmitter location. As an example, transmit at −10 dBm in the uplinks. Using the propagation predictor the invention computes the signal strength versus location for both uplinks and as a result of this compute the difference in the uplink signal strengths. This is the difference in the uplink losses since the uplink transmit powers are the same. Hence at locations where the differences in uplink signal strengths are 40 dBm are potential locations for the transmitter. These are reduced to one location by introducing more receiver pairs as described earlier.

The localisation problem addressed here (for illustrative purposes) is an outdoor problem but the principle on which this method is based is valid for both indoor and outdoor scenarios. As referred to earlier the propagation predictor used here is based on the EFIE. The surface, terrain, is modelled as a Perfect Electric Conductor (PEC) which has been shown to be a valid model for terrain-based transmission in where the signal strength above the surface was computed using the canonical form of the EFIE and the results compared with measurements.

As noted, it is not surprising that the PEC model is a good model for terrain based transmission since much of the radiation from the transmitter will be at grazing incidence, a result of which the reflection coefficient will be close to unity. The transmitter used in J. T. Hviid, J. B. Andersen, J. Toftgard, and J. Bojer, “Terrain-Based Propagation Model for a Rural Area—An Integral Equation Approach,” IEEE Trans. Antennas Propag., vol. 43, pp. 41-46, 1995 was placed 10.4 m above the surface. Measurements were taken at 2.4 m above the ground for various terrain profiles in Denmark at various frequencies.

The EFIE algorithm used in the invention can be an accelerated algorithm and has been shown to give excellent agreement with the numerically exact solution and to within a standard deviation of about 8 dB with respect to measurements at very high speeds.

In both scenarios the propagation over this type of terrain is addressed, to what is often referred to as, the 2.5D problem. In other words the problem is presented as a classical 2D problem. However a third dimension exists but, under the assumption that side-scattering is approximately equal from both sides, has been integrated out.

Propagation Model

A synopsis of the integral equation (IE) method, on which the propagation predictor is based, is given here and is referred to as the Field Extrapolation Method (FEXM), as disclosed E. O Nuallain, “An Efficient Integral Equation-Based Propagation Model”, IEEE Trans. Ant. Prop. Vol. 53, May 2005.

The FEXM yields values for the Path-Loss and the Large-Scale fading signal. The Small-Scale Fading signal must be treated separately—probably best as a statistical model. The problem is treated as two-dimensional TMz, the surface is taken to be a perfect electrical conductor (PEC) and forward scattering is assumed—that is all radiation is taken to propagate away from the transmitter.

The latter two assumptions are justifiable in the case of grazing incidence of transmitter radiation which is predominantly the case for the terrain profiles examined here. All are simplifying and not limiting assumptions. The surface is impinged by a monochromatic TMz polarized cylindrical wave of wave number B emanating from an infinite, unit current carrying wire of negligible cross-section, placed a distance above and transverse to the terrain profile. A time variation e^{jar} of is assumed and suppressed. An electric current J is induced on the surface, which satisfies the EFIE:

$$E ( r ) = \frac{βη}{4} {\int }_{s} J ( {r}^{′} ) {H}_{0}^{( 2 )} ( β \vert r - {r}^{′} \vert ) d {r}^{′} . \qquad ( 2 )$$

Where r and r′ are vectors whose end-points are respectively the scattering and receiving points s∈S. E(r) is the source electric field incident on the surface at the point given by r. N is the wave impedance of the medium through which the radiation propagates and H₀⁽²⁾ is a zero order Hankel function of the second kind which is the Green's function for the problem.

The surface is discretized into N equal sized sampling intervals of length Δs with centrepoints indicated by the vectors rᵢ and rⱼ depending on whether they are scattering or receiving intervals respectively. Using the Method of Moments with unit pulse basis functions and Dirac-delta weighting functions the following matrix relation is obtained:

$$\begin{matrix}E = ZJ . \\ where & ( 3 a ) \\ \begin{matrix}{E}_{i} = E ( {r}_{i} ) \\ {Z}_{ji} \approx Δ s \frac{βη}{4} {H}_{0}^{( 2 )} ( β \vert {r}_{j} - {r}_{i} \vert ) \\ {Z}_{jj} \approx Δ s \frac{βη}{4} ( 1 - j \frac{2}{π} ln ( \frac{1.781 βΔ s}{4 e} ) ) \\ {J}_{j} = J ( {r}_{j} ) .\end{matrix} & ( 3 b . )\end{matrix}$$

E and J are column vectors of length N. Z, known as the impedance matrix, is N×N and symmetric. The elements in the strictly lower triangle of Z correspond to forward-scattering and those in the strictly upper triangle to back-scattering.

The diagonal elements correspond to the self-interaction of the sampling intervals. On the assumption of forward scattering, which is equivalent to setting the strictly upper triangular elements of Z to zero, J is determined by forward substitution:

$${E}_{i} = {\sum }_{j = 1}^{j \leq i} {J}_{j} {Z}_{ji} for i = 1 ⋯ N . \qquad ( 4 )$$

The order of complexity of determining is J is O(N²). The total field at points above the surface is then the sum of the field from the source and the field scattered by the surface.

The surface is divided into groups each containing M sampling intervals. There are then N/M such groups. Under two central assumptions: 1) The induced surface current is sinusoidal with an a-priori assumed envelope (e.g. Rayleigh distributed) and 2) the phase shift for each group can be forced to zero. Equation (3) can then be manipulated such that the following equation ensues:

$$\begin{matrix}{E}_{i} = K {\sum }_{{I}^{′} < l} {J}_{{I}^{′}} {Z}_{{I}^{′} l} + {J}_{{I}^{′}} {Z}_{ll} , \\ where & ( 5 ) \\ K = 1 - {\sum }_{j ∈ {G}_{l}} \frac{{e}^{- {jβs}_{j}} {Z}_{jl}}{{Z}_{ll}} & ( 6 )\end{matrix}$$

which is approximately constant for all groups and consequently needs only to be evaluated once thereby obviating the need for time-consuming group-specific aggregation or disaggregation stages. Equation (4) takes the form of (3) and use of the latter over the former results in a reduction in the complexity from O(N²) to O((N/M)²) and a reduction in memory requirements from O(N) to O((N/M)). The total field at points t above the surface is determined using a similar analysis giving:

$${E}_{t}^{total} = {E}_{t} + K {\sum }_{{I}^{′} = 1}^{{I}^{′} < t} {J}_{{l}^{′}} {Z}_{{I}^{′} l} for t = 1 , 2 , ⋯ , \frac{N}{M} . \qquad ( 7 )$$

M may be determined in heuristic fashion—it does not appear to vary for similar terrain types.

Implementation

The receiver locations were chosen randomly with the exception of a deliberate avoidance of the region close to the transmitter (where it could not be considered a point source) and the regions around 3.5 and 6.5 Km distant from the transmitter where there is significant deviation between simulated results and measurements. The receiver locations and corresponding measurements are given in Table 1:

TABLE 1
Location of receivers versus location and their measured signal strengths.

| Receiver | X Ordinate | Y Ordinate | Measured Signal |
|---|---|---|---|
| (A-Z) | (m) | (m) | Strength (dB) |
| A | 1500.0 | 7.4 | −100.573 |
| B | 5500.0 | 46.4 | −107.0 |
| C | 5250.0 | 41.0 | −112.97 |
| D | 2500.0 | 16.4 | −97.2 |
| E | 4500.0 | 34.4 | −120.25 |
| F | 7000.0 | 48.4 | −122.22 |
| G | 2000.0 | 7.4 | −102.51 |
| H | 6000.0 | 53.5 | −122.41 |
| J | 6500.0 | 42.4 | −140.62 |
| K | 5250.0 | 41.0 | −112.97 |
| L | 3000.0 | 26.4 | −99.06 |
| M | 5750.0 | 58.6 | −109.4 |

There are many potential locations for the transmitter rₒ. Therefore there is a need to specify a residual function calculation that includes a minimisation process to obtain the best location.

Let the set rₖ:m=1,2, . . . , M; n=1,2, . . . , N form a lattice of potential BTS location points. Then the residual function based on Eqn. (1) becomes:

εₖᵢⱼ≡ΔLₖᵢⱼ^{d}−ΔLᵢⱼₖ^{u} (8)

Next the absolute values of the residual functions over a complete set of R receiver pairs {n}₁^{R}, are used to give us a sum of the residuals:

Ξₖ=Σᵢ₌₁^{R}Σⱼ₌₁ⁱεₖᵢⱼ (9)

To eliminate spurious local minima a moving average over the lattice of sums of residuals {Ξₖ:m=1,2, . . . M; n=1,2, . . . , N} is taken. As a result of this process some local minima in Eqn. 9 that do not correspond to the transmitter location are eliminated and a clearer picture emerges as to the location of the transmitter which should be located at or near the absolute minimum of this function.

Clearly the more receiver pairs used the greater the probability of achieving precise localization. A summary of the procedure is given here:

1) The differences in measured RSS for each receiver pair (rᵢ, rj) in the downlink, ΔLₖᵢⱼ^{d} are calculated for a lattice of potential transmitter locations {rₖ}

2) The differences in the uplink SS, ΔLᵢⱼₖ^{k}, using the receiver pairs pair (rᵢ, rj) for potential transmitters{rk}, each transmitting with the same arbitrary power, are calculated as a function of location in 2-D space. The FExM propagation predictor with the terrain profile as an input is used for this purpose.

3) The residual function εₖᵢⱼ is calculated for each receiver pair and each potential transmitter as in Eqn. (8).

4) The discrete function Ξₖ is calculated from 3) summing over all receiver pair groupings as in Eqn. (9).

5) The discrete function Ξₖ is smoothed to eliminate spurious minima.

6) The absolute minimum of min(Ξ)=min_{∀k}Ξₖ is determined using a search routine.

Results

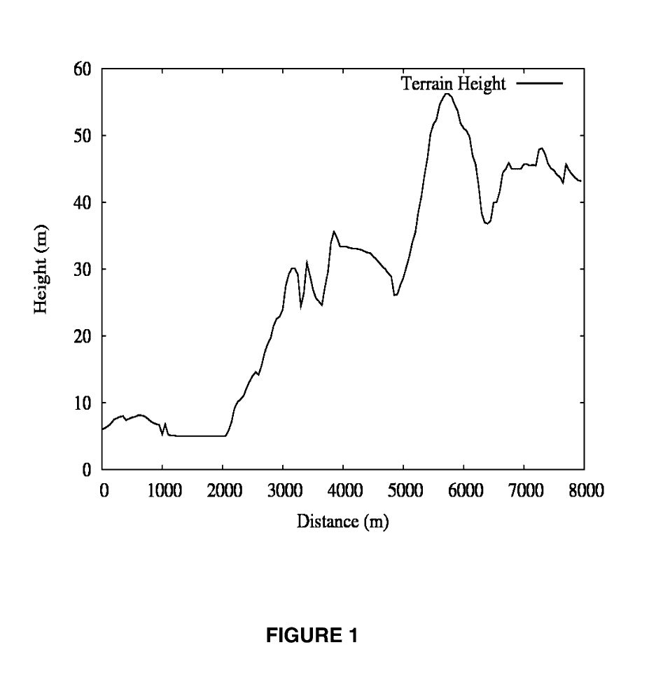

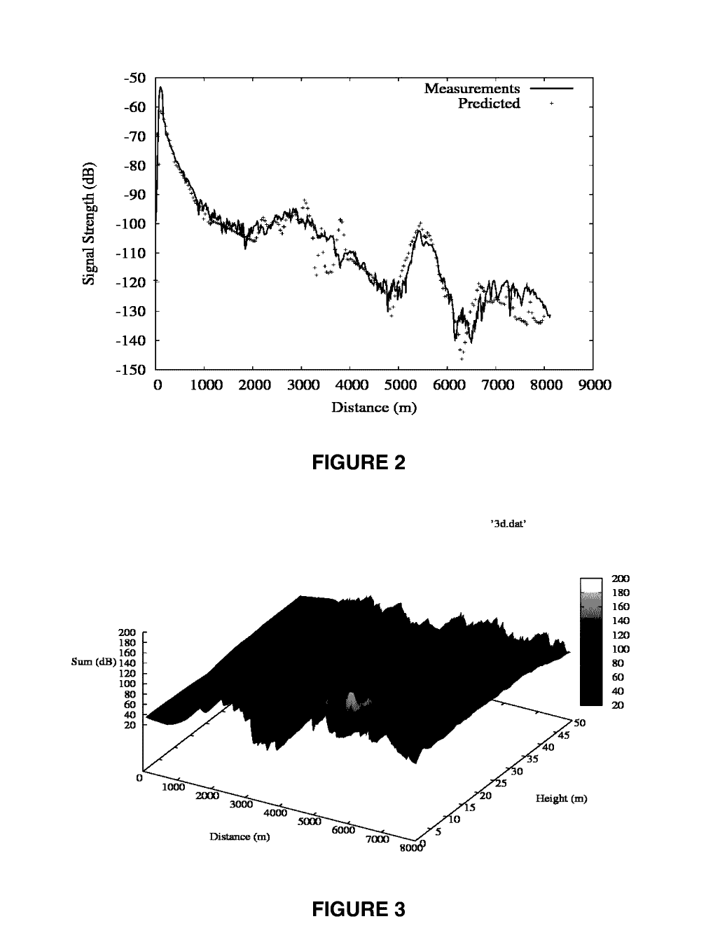

The profile examined here is the Hadsund profile in Denmark shown in FIG. 1. The transmitter is placed 10.4 m above the ground at the starting point which is 6 m above sea-level. The undulating, generally rural terrain then rises to a maximum height of 56.2 m before dropping off again. The length of the terrain profile is approx. 8 Km. There are non-line-offsight (NLOS) conditions between about 3 and 5 Km and again from about 6 to 8 Km.

The region is both wooded and suburban in places. The frequency used is 435 MHz. The entire program was run on an Intel Xeon E5-4640, 2.4 GHz processor. The operating system used was Debian Linux 6.0. The groupsize (M) used in the propagation predictor is of approximately 13.0 m in length. The search (for the absolute minimum) was performed over the length of the surface (7.8 Km) and up to 50 m above the surface again in steps of 1.0 m. If a smaller step size is used then there is greater accuracy in the localisation. The result obtained for the location of the transmitter is x=20.0 m, y=13.7 m as opposed to its true value x=0.0 m, y=16.4 m. This corresponds to an error of 13.69 m. The execution time was 89 s.

As can be seen from FIG. 3, there are other local minima. Those from about 3.0 to 4.0 Km potentially act as erroneous predictions for the location of the transmitter. This can occur as a result of measurements at receiver pairs not being in agreement with predicted values.

The three challenges set out at the beginning of this paper have been addressed here. Firstly the transmitter has been localized from signal strength readings taken over an outdoor profile without the cooperation of the transmitter itself. Secondly the localization has been performed using signal strength meters and modest computational resources making this approach a cost-effective one. Thirdly the location accuracy is about 13.7 m when six pairs of receivers are used. This compares well with GPS accuracy of about 10 m in unobstructed environments, while 2G and 3G systems have an achievable accuracy in the neighbourhood of 100 m. Location accuracy improves with an increasing number of receivers. It is believed that this accuracy can also be improved over time using more sophisticated algorithms/data processing.

Other advantages of the method include the capability of the algorithm to deal with NLOS conditions, its inherent resilience to signal fading and multipath, there is no requirement that the receivers in the algorithm presented to be static, and there is no need for anchor nodes and no synchronization requirement. Although heuristic values for the group size in the propagation program, the number and location of the receivers were chosen the results obtained are encouraging demonstrating the effectiveness of this technique.

The propagation model used has been shown to be accurate for the types of profile examined here. However, bettering the propagation model can only have a beneficial effect on localization accuracy.

Another important problem would be the case where there are more than one transmitters transmitting in the same band in which case the signal strength versus location of known transmitters as determined by the propagation predictor would be subtracted from the residual function.

### Second Embodiment

Where the transmitter power is known the invention can use the following methodology.

By direct application of the Helmholtz Reciprocity Theorem one can obtain a set of potential locations rₒ for a BTS (Base Station Transceiver) whose output power Pₒ is known by taking the RSS (Received Signal Strength) at a mobile transceiver location rᵢ and using a propagation predictor which predicts the signal loss Lₒᵢ from that mobile transceiver were a transmitter with the same output power Po (i.e. as that of the transmitter) placed there. At those locations where the computed SS (Signal Strength) are the same as the originally read RSS at the location mentioned above, potential locations for the original transmitter can be obtained. If this process is repeated for a number of receiver locations then incorrect transmitter locations can be eliminated until just one location for the transmitter is left. This method however requires knowledge of the transmit power.

Where the power of the BTS is not known the above methodology described with respect to equations 1 to 9 can be used.

The embodiments in the invention described with reference to the drawings comprise a computer apparatus and/or processes performed in a computer apparatus. However, the invention also extends to computer programs, particularly computer programs stored on or in a carrier adapted to bring the invention into practice. The program may be in the form of source code, object code, or a code intermediate source and object code, such as in partially compiled form or in any other form suitable for use in the implementation of the method according to the invention. The carrier may comprise a storage medium such as ROM, e.g. CD ROM, or magnetic recording medium, e.g. a memory stick or hard disk. The carrier may be an electrical or optical signal which may be transmitted via an electrical or an optical cable or by radio or other means.

In the specification the terms “comprise, comprises, comprised and comprising” or any variation thereof and the terms include, includes, included and including” or any variation thereof are considered to be totally interchangeable and they should all be afforded the widest possible interpretation and vice versa.

The invention is not limited to the embodiments hereinbefore described but may be varied in both construction and detail.

What is claimed is:

1. A method of locating a non-cooperative transmitter in a network based on a received signal strength (RSS) comprising the steps of:
observing differences in both downlink and uplink signal losses for the transmitter to be located and a minimum of one receiver pair;
calculating the differences in downlink signal losses for each receiver pair obtained by measuring the RSS;
comparing the calculated values generated for the uplink using a propagation predictor; and
predicting a location of the non-cooperative transmitter in the network from the comparing step.

2. The method of claim 1 wherein an integral equation-based propagation predictor is used as a result of its ability to give an accurate prediction of large-scale fading.

3. The method of claim 1 wherein the propagation predictor is based on a Helmholtz Reciprocity Theorem,

4. The method of claim 1 wherein the differences in measured RSS for each receiver pair (ri, rj) in the downlink, ΔLₖᵢⱼ^{d} are calculated for a lattice of potential transmitter locations {rk}.

5. The method of claim 1 wherein the differences in the uplink is SS, ΔLᵢⱼₖ^{k} is calculated using the receiver pairs pair (ri, rj) for potential transmitters {rk}, each transmitting with a same arbitrary power, are calculated as a function of location using said propagation predictor.

6. The method of claim 1 wherein a residual function εkij is calculated for each receiver pair and each potential transmitter as defined by the following equation:
εₖᵢⱼ [symbol] ΔLₖᵢⱼ^{d}−ΔLᵢⱼₖ^{u}

7. The method of claim 1 wherein a discrete function Ξₖ calculated by summing over all receiver pair groupings as defined by:
$${Ξ}_{k} = {\sum }_{i = 1}^{R} {\sum }_{j = 1}^{i} {∈}_{kij}$$

8. The method of claim 7 wherein the discrete function Ξₖ is smoothed to eliminate spurious minima.

9. The method claim 1 wherein the location of the transmitter is estimated to be given by the location of an absolute minimum wherein the absolute minimum can be defined as the absolute minimum of min(Ξ)=min_{∀k}Ξₖ determined using a search routine.

10. A computer implemented system for locating a non-cooperative transmitter in a network based on a received signal strength (RSS), said system configured with one or more modules to:
observe differences in both downlink and uplink signal losses for the transmitter to be located and a minimum of one receiver pair;
calculate the differences in downlink signal losses for each receiver pair obtained by measuring the RSS;
compare the calculated values generated for the uplink using a propagation predictor; and
predict a location of the non-cooperative transmitter in the network from the comparison.

11. The computer implemented system of claim 10 wherein an integral equation-based propagation predictor is used as a result of its ability to give an accurate prediction of large-scale fading.

12. The computer implemented system of claim 10 wherein the propagation predictor is based on a Helmholtz Reciprocity Theorem,

13. The computer implemented system of claim 10 wherein the differences in measured RSS for each receiver pair (ri, rj) in the downlink, ΔLₖᵢⱼ^{d} are calculated for a lattice of potential transmitter locations {rk}.

14. The computer implemented system of claim 10 wherein the differences in the uplink SS, ΔLᵢⱼₖ^{k} is calculated using the receiver pairs pair (ri, rj) for potential transmitters {rk}, each transmitting with a same arbitrary power, are calculated as a function of location using said propagation predictor.

15. The computer implemented system of claim 10 wherein a residual function εkij is calculated for each receiver pair and each potential transmitter as defined by the following equation:
εₖᵢⱼ [symbol] ΔLₖᵢⱼ^{d}−ΔLᵢⱼₖ^{u}

16. The computer implemented system of claim 10 wherein a discrete function Ξₖ calculated by summing over all receiver pair groupings as defined by:
$${Ξ}_{k} = {\sum }_{i = 1}^{R} {\sum }_{j = 1}^{i} {∈}_{kij}$$

17. The computer implemented system of claim 10 wherein the location of the transmitter is estimated to be given by the location of an absolute minimum wherein the absolute minimum can be defined as the absolute minimum of min(Ξ)=min_{∀k}Ξₖ determined using a search routine.
